(19) United States
(12) Patent Application Publication
(10) Pub. No.: US 2020/0275530 A1
(43) Pub. Date: Aug. 27, 2020

(54) POSITIVE TEMPERATURE COEFFICENT HEATERS AND CONTACT APPLICATIONS THEREOF

(71) Applicant: GM GLOBAL TECHNOLOGY OPERATIONS LLC, Detroit, MI (US)

(72) Inventors: Chih-hung Yen, Bloomfield Hills, MI (US); Kuo-huey Chen, Troy, MI (US); Taeyoung Han, Bloomfield Hills, MI (US); Shailendra Kaushik, Novi, MI (US); Bahram Khalighi, Birmingham, MI (US); Paul E. Krajewski, Troy, MI (US); Alok Warey, Novi, MI (US)

(21) Appl. No.: 16/287,062

(22) Filed: Feb. 27, 2019

(51) Int. Cl. H05B 3/00; H05B 3/12

(52) U.S. Cl. CPC H05B 3/0014; H05B 3/12; H05B 2203/028; H05B 2203/029; H05B 2203/02

(57) ABSTRACT

A contact heating apparatus is provided. The heating apparatus includes a positive temperature coefficient (PTC) heating element integrated into a contact surface, a power controller configured to generate and apply a pulse width modified signal to the PTC heating element, and a controller is configured to adjust a current of the pulse width modified signal of the power controller according to one or more from among a setting parameter and a profile.

### CROSS REFERENCE TO RELATED APPLICATIONS

The present application is related to U.S. application Ser. No. 16/286,881 entitled Positive Temperature Coefficient Heaters and Radiant Applications Thereof (GM Docket Number P048157-US-NP) filed on Feb. 27, 2019, the disclosure of which is hereby incorporated herein in its entirety.

### INTRODUCTION

Apparatuses and methods consistent with exemplary embodiments relate to configurations of radiant heating devices. More particularly, apparatuses and methods consistent with exemplary embodiments relate to the integration of radiant heaters in vehicles.

### SUMMARY

One or more exemplary embodiments provide a contact positive temperature coefficient heater integrated into vehicle or component. More particularly, one or more exemplary embodiments provide a contact positive temperature coefficient apparatus, and deployment and integration methods thereof.

According to an aspect of an exemplary embodiment, a contact heating apparatus is provided. The apparatus includes a positive temperature coefficient (PTC) heating element integrated into a contact surface, a power controller configured to generate and apply a pulse width modified signal to the PTC heating element, and a controller is configured to adjust a current of the pulse width modified signal of the power controller according to one or more from among a setting parameter and a profile.

The contact surface may be one or more from among an upper front side of a seat, a seating surface of a seat, an edge of a seat face, an armrest of a seat, a tray, a center console, an armrest of a center console, an armrest of a door, a steering wheel, a vehicle integrated blanket, and a cupholder.

The setting parameter may be one or more from among a setting input by an occupant, a pre-calibrated setting corresponding to a location of the PTC heating element, a temperature of a space, and a surface temperature of the contact surface into which the PTC heating element is integrated.

The profile may include a profile of an occupant that is occupying a space or touching the contact surface corresponding to the PTC heating element. The profile of the occupant may also include information on temperature preferences of the occupant or PTC heating element intensity preferences of the occupant.

The PTC heating element may be integrated into a cupholder.

The setting parameter may include one or more from a drink setting input by an occupant, a pre-calibrated temperature corresponding to a drink or entree, a temperature of a space configured to hold a drink or entree, and a surface temperature of the contact surface configured to hold a drink or entree. The profile may also information on drink temperature preferences of an occupant or drink type preferences of an occupant.

The PTC heating element may be a cylindrical structure including a plurality of fold lines running around a circumferential axis such that the cylindrical structure expands and retracts along a longitudinal axis of the cylindrical structure.

The PTC heating element may be integrated into an inflatable blanket configured to deploy in a vehicle.

The setting parameter may be a thermal comfort value or an optimal power consumption value.

The setting parameter comprises an equivalent homogenous temperature.

The controller may be configured to control the PTC heating element and other HVAC systems according to the setting parameter and the profile.

The communication device may be configured to receive the setting parameter from one or more from among a plurality of sensors.

The communication device may be further configured to receive the profile from one or more of a server and a mobile device.

The user input may be configured to provide the setting parameter to the controller.

The apparatus may further include a storage configured to store the setting parameter and the profile.

The PTC heating element may include a ceramic material or silicon rubber.

The PTC heating element may include flexible substrate and carbon-based ink.

The PTC heating element may be flexible.

Other objects, advantages and novel features of the exemplary embodiments will become more apparent from the following detailed description of exemplary embodiments and the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 shows a block diagram of a contact heating apparatus according to an exemplary embodiment;

FIGS. 2A and 2B show illustrations of a positive temperature coefficient heating element and a graph illustrating the resistance of a positive temperature coefficient heating element corresponding to a temperature of a positive temperature coefficient heating element according several aspects of exemplary embodiments;

FIG. 3 shows an illustration of several positive temperature coefficient heating elements integrated into various contact areas in a vehicle according to several exemplary embodiments;

FIG. 4 shows various illustrations of several positive temperature coefficient heating elements integrated into various contact areas in a vehicle according to several exemplary embodiments;

FIG. 5 shows an illustration of a positive temperature coefficient heating element integrated into a cupholder according to an exemplary embodiment; and

FIG. 6 shows an illustration of a positive temperature coefficient heating element integrated into an inflatable blanket according to an exemplary embodiment.

### DETAILED DESCRIPTION

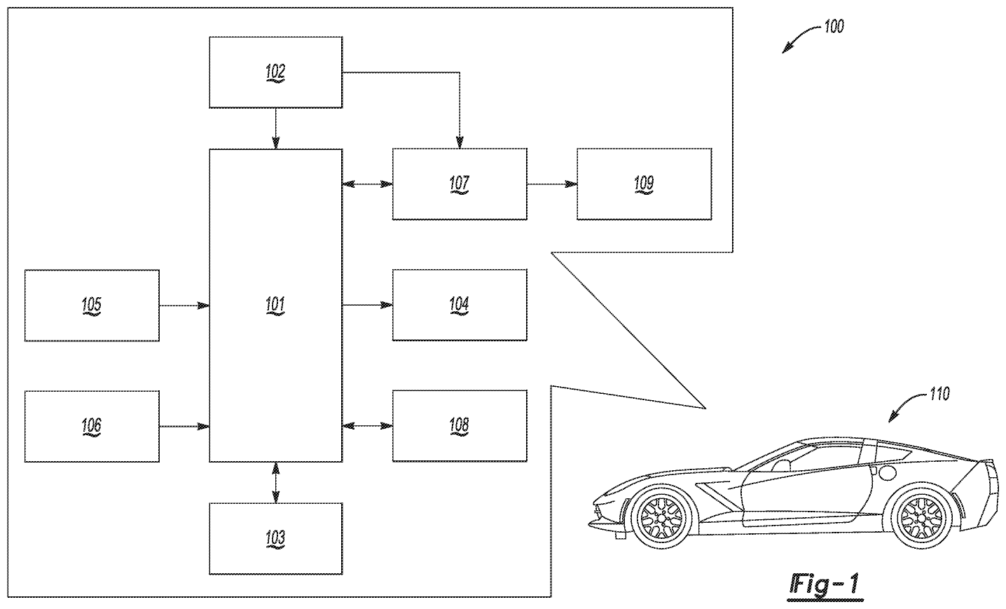

A heating apparatus will now be described in detail with reference to FIGS. 1-6 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Most vehicles are equipped with a heating core and blower that forces air through the heating core to transfer heat from the coolant in the heating core to the cabin air system. The heating core and blower heating system requires vents and fans which take up space in the vehicle. Moreover, with the development of electric vehicles, engines and engine coolant will no longer be required in vehicles. Thus, an alternative apparatus for heating a vehicle space or cabin or vehicle components and providing occupant comfort will be required.

In many current vehicles, seats and steering wheels are heated by resistance heaters. One type of heater is a positive temperature coefficient (PTC) heating element. A PTC heating element turns electrical energy into heat and may be flexible allowing for various types of integrations. Further, the resistance of the PTC heating element increases as temperature increases thereby effectively regulating the temperature of the surface into which the PTC heating element is integrated. The aforementioned features of the PTC heating element make it possible to integrate the PTC heating element into various contact surfaces providing for a more comfortable occupant and for additional conveniences enabled by heated surfaces.

FIG. 1 shows a block diagram of a heating apparatus according to an exemplary embodiment. As shown in FIG. 1, the contact heating apparatus 100, according to an exemplary embodiment, includes a controller 101, a power supply 102, a storage 103, an output 104, a sensor 105, a user input 106, a power controller 107, a communication device 108 and a PTC heating element 109. However, the contact heating apparatus 100 is not limited to the aforementioned configuration and may be configured to include additional elements and/or omit one or more of the aforementioned elements. The contact heating apparatus 100 may be implemented as part of a vehicle, as a standalone component, or as a hybrid between an on vehicle 110 and off vehicle device.

The controller 101 controls the overall operation and function of the contact heating apparatus 100. The controller 101 may directly or indirectly control one or more of a power supply 102, a storage 103, an output 104, a sensor 105, a user input 106, a power controller 107, a communication device 108 and a PTC heating element 109, of the contact heating apparatus 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the power supply 102, the storage 103, the output 104, the sensor 105, the user input 106, the power controller 107, the communication device 108 and the PTC heating element 109 of the contact heating apparatus 100. The information may be sent and received via a bus or network, or may be directly read or written to/from one or more of the power supply 102, the storage 103, the output 104, the sensor 105, the user input 106, the power controller 107, the communication device 108 and the PTC heating element 109 of the contact heating apparatus 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

According to an example, the controller 101 is configured to adjust amplitude and frequency of a current or voltage of the pulse width modified signal of the power controller 107 according to one or more from among a setting parameter and a profile.

The power supply 102 provides power to one or more of the storage 103, the output 104, the sensor 105, the user input 106, the power controller 107, the communication device 108 and the PTC heating element 109, of the contact heating apparatus 100. The power supply 102 may include one or more from among a battery, an outlet, a capacitor, a solar energy cell, a generator, a wind energy device, an alternator, etc.

The storage 103 is configured for storing information and retrieving information used by the contact heating apparatus 100. The information may include information setting parameter or a profile.

The setting parameter may include one or more from among a setting input by an occupant via user input 106, a pre-calibrated prestored setting corresponding to a location of the PTC heating element, a temperature of a space recorded by a sensor 105, and a surface temperature of a contact surface into which the PTC heating element is integrated recorded by a sensor 105. The setting parameter may also be one or more from a drink setting input by an occupant, a pre-calibrated temperature corresponding to a drink, a temperature of a space configured to hold a drink or entree, and a surface temperature of the contact surface configured to hold a drink or entree.

According to another example, the setting parameter may include a thermal comfort value, an equivalent homogeneous temperature and/or an optimal power consumption value. The equivalent homogeneous temperature value may be determined based on information including one or more form among air temperature, air flow rates, radiative heat flux, and humidity provided by a sensor 105. Thermal comfort is an occupant comfort rating at a given equivalent homogenous temperature or for a given combination of settings of the HVAC components.

The optimal power consumption value is a minimum power consumption value corresponding to thermal comfort value of an occupant. The minimum power consumption value is achieved by coordinating settings of HVAC components to provide a desired or maximum thermal comfort value and determining all of the various combination of settings of the HVAC components that consume the least amount of power for the desired or maximum thermal comfort value of an occupant.

The profile may be a profile of an occupant. For example, the profile may be a profile of an occupant that is occupying a space or touching the contact surface corresponding to the PTC heating element. The profile of the occupant may include information on desired thermal comfort value of the occupant for a given season, weather, time of day, etc., temperature preferences of the occupant or PTC heating element intensity preferences of the occupant. In another example, the profile may be a drink or meal profile. The drink profile may include information on drink temperature preferences of an occupant or drink type preferences of an occupant. The meal profile may include information on a temperature required to keep a meal warm.

The storage 103 may be controlled by the controller 101 to store and retrieve information received from one or more sensors 105 as well as computer or machine executable instructions to control the PTC heating element 109. The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the contact heating apparatus 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the activation or deactivation of the PTC heating element 109 or the contact heating apparatus 100. The output 104 may also display image and information provided by one or more sensors 105. The output 104 may display a graphic illustrating positions of the PTC heating elements 109 and indicating their statuses, e.g., on, off, power setting, etc.

The sensor 105 may include one or more from among a thermometer, a power sensor, and a temperature sensor. The power sensor may be a current sensor, voltage sensor, or other sensor detect the current or other power value of the signal being output to the PTC heating element 109.

The user input 106 is configured to provide information and commands to the contact heating apparatus 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to activate or deactivate the contact heating apparatus 100.

The power controller 107 may include circuitry including a signal generator such as a pulse generator (e.g., a solid-state pulse generator) and an amplifier. In addition, the power controller 107 may include a direct current to direct current convertor and pulse generator such as a solid-state pulse generator. According to one example, the power controller may include transformer configured to convert AC power supplied by the power supply to an AC voltage and frequency to power the PTC heating element. According to another example, the power controller may include a direct current (DC) to DC converter configured to convert the power supplied by the power supply to an appropriate voltage and frequency to power the PTC heating element. According to yet another example, the power controller may be configured to convert current, voltage, waveform, and frequency of electricity inputs and generate an output signal according to the converted current, voltage, waveform, and frequency for the PTC heating element.

The communication device 108 may be used by contact heating apparatus 100 to communicate with several types of external apparatuses according to various communication methods. The communication device 108 may be used to send/receive various information such as setting parameter and a profile information for operating the contact heating apparatus 100 to/from the controller 101 from/to various external device such as phones, USB devices, etc.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

The PTC heating element 109 is an electrical device that generates heat when an electrical current is passed through the element. The heating element is self-regulating and self-limiting because the electrical resistance of the element increases as the element's temperature rises. In particular, PTC heating element 109 may be a flexible substrate and with a printed ink or a rubber. The PTC heating element 109 may comprise ceramic, silicon rubber or carbon-based ink applied to a plastic film.

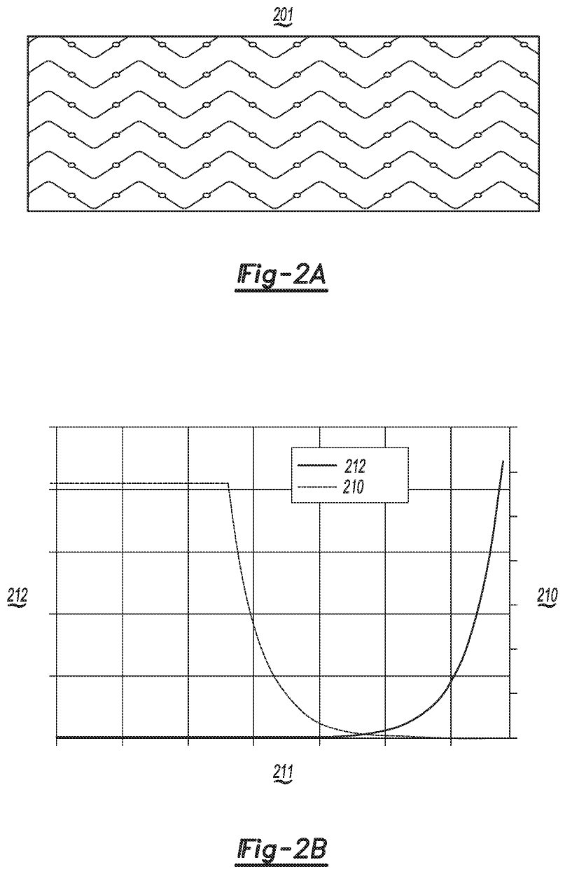

FIGS. 2A and 2B show illustrations of a positive temperature coefficient heating element and a graph illustrating the resistance of a positive temperature coefficient heating element corresponding to a temperature of a positive temperature coefficient heating element according several aspects of exemplary embodiments.

Referring to FIG. 2A, a flexible PTC heating element 201 is shown. The PTC heating element 201 includes a pattern printed onto a substrate that is connected to two electrodes configured to receive power. The application of power to the electrodes causes the printed pattern to radiate heat.

Referring to FIG. 2B, a graph of showing the power values 210 of a pulse width modified signal applied to the PTC heating elements and the resistance 212 of the PTC heating element, and the temperature 211 of the PTC heating element corresponding to the power and resistance values.

The exemplary embodiment illustrated in graph shows that when the pulse width modified signal is powered on, the resistance 212 increases as the temperature 211 increases thereby causing the temperature of the PTC heating element to increase. However, the power 210 of the signal begins to decrease as the temperature 211 increases and drops to near zero or negligible amount thereby limiting the maximum temperature of the PTC heating element.

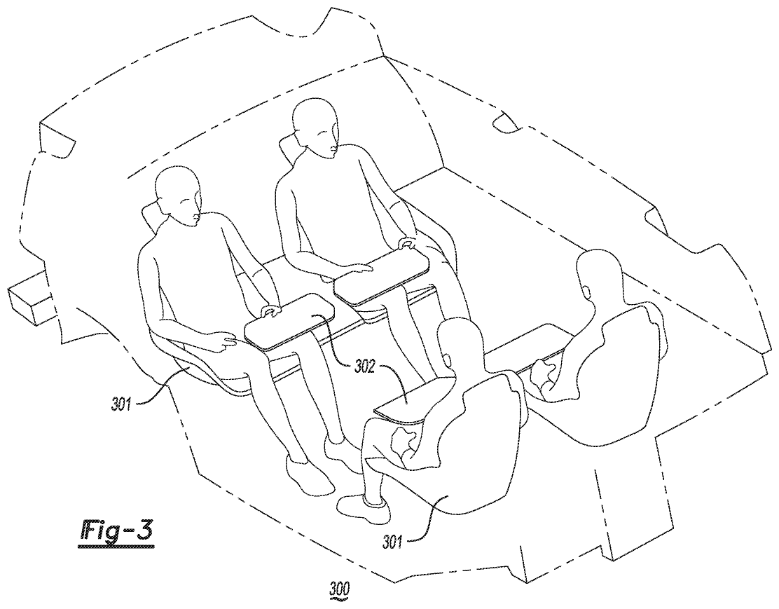

FIG. 3 shows an illustration of several positive temperature coefficient heating elements integrated into various contact areas in a vehicle according to several exemplary embodiments.

Referring to FIG. 3, an illustration 300 of PTC heating elements 109 is shown. The PTC heating elements 109 may be integrated into one or more from among a seating surface, a tray, arm rests, a tulip seat. The PTC heating elements 109 may integrated into a contact side of the seating surface, tray 302, armrests, tulip seats 301, etc. For example, the PTC heating elements 109 may be integrated into the side that is intended to contact with an occupant, a drink or a metal.

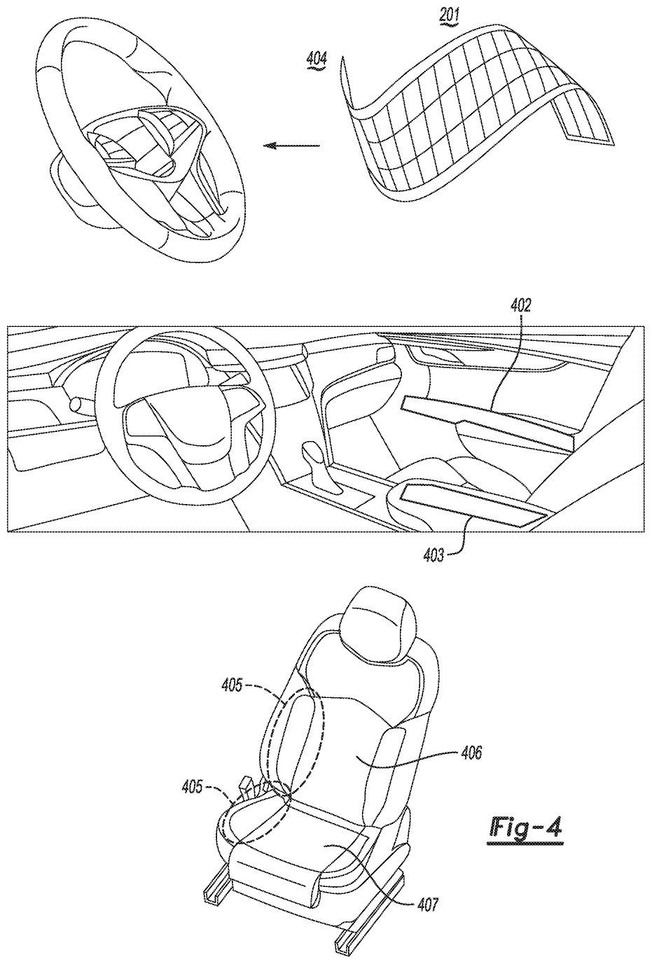

FIG. 4 shows various illustrations of several positive temperature coefficient heating elements integrated into various contact areas in a vehicle according to several exemplary embodiments.

Referring to FIG. 4, the PTC heating element 201 may be integrated into one or more from among is a center console or an armrest of a center console 403, an armrest of a door 402, a steering wheel 404. In another example, the PTC heating element 201 may be integrated into edges of a seat face 405 as well as an upper front side of a seat 406, a seating surface of a seat 407.

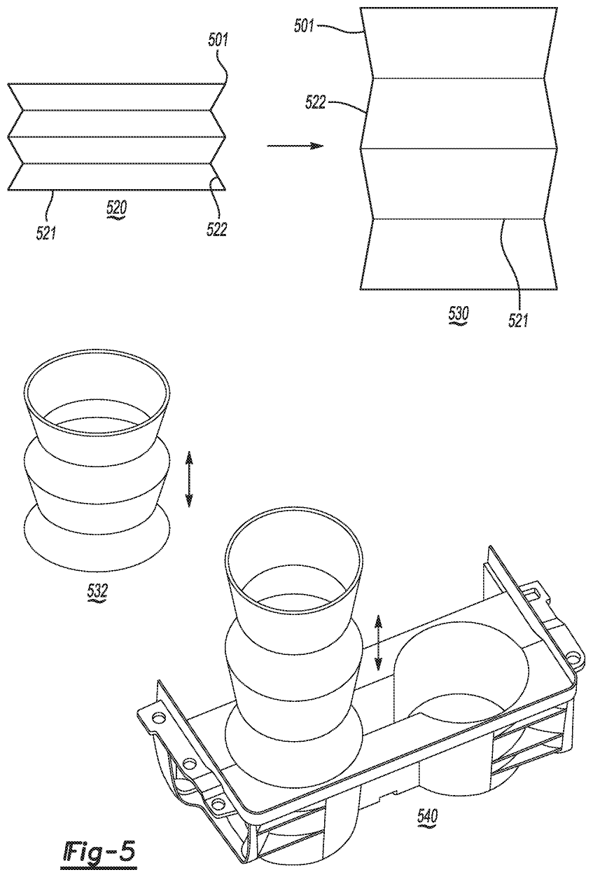

FIG. 5 shows an illustration of a positive temperature coefficient heating element integrated into a cupholder according to an exemplary embodiment.

Referring to FIG. 5, in one example, the PTC heating element 501 may include a cylindrical structure 532. The cylindrical structure 532 may include a plurality of fold lines 521 running around a circumferential axis such that the cylindrical structure expands 530 and retracts 520 along a longitudinal axis of the cylindrical structure 532. In addition, the cylindrical structure 532 may include support arms 522 arranged along the cylindrical wall. The cylindrical structure 532 may be integrated into a cupholder 540 and configured to heat drinks.

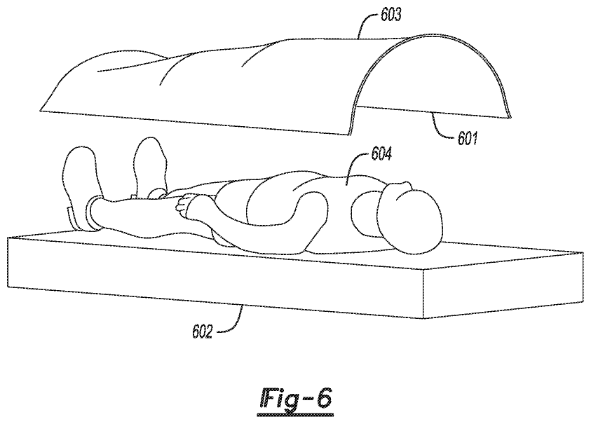

FIG. 6 shows an illustration of a positive temperature coefficient heating element integrated into an inflatable blanket according to an exemplary embodiment.

Referring to FIG. 6, a blanket 603 is shown. The blanket may be an inflatable blanket and/or may be integrated into a vehicle compartment, bench, bed, seat etc. The blanket 601 may include a PTC heating element 601 on a contact side of the blanket or the side that is intended to make contact with an occupant 604. In FIG. 6, the occupant 604 is lying a bed or bench 602. The bed or bench 602 may be part of a vehicle and may also include a PTC heating element 601 on a contact side or the side that is intended to make contact or carry the occupant 604.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A contact heating apparatus, the apparatus comprising:
a positive temperature coefficient (PTC) heating element integrated into a contact surface;
a power controller configured to generate and apply a pulse width modified signal to the PTC heating element; and
a controller is configured to adjust a current of the pulse width modified signal of the power controller according to one or more from among a setting parameter and a profile.

2. The apparatus of claim 1, wherein the contact surface is one or more from among an upper front side of a seat, a seating surface of a seat, an edge of a seat face, an armrest of a seat, a tray, a center console, an armrest of a center console, an armrest of a door, a steering wheel, a vehicle integrated blanket, and a cupholder.

3. The apparatus of claim 1, wherein the setting parameter comprises one or more from among a setting input by an occupant, a pre-calibrated setting corresponding to a location of the PTC heating element, a temperature of a space, and a surface temperature of the contact surface into which the PTC heating element is integrated.

4. The apparatus of claim 1, wherein the profile comprises a profile of an occupant that is occupying a space or touching the contact surface corresponding to the PTC heating element.

5. The apparatus of claim 4, wherein the profile of the occupant comprises information on temperature preferences of the occupant or PTC heating element intensity preferences of the occupant.

6. The apparatus of claim 1, wherein the PTC heating element is integrated into a cupholder.

7. The apparatus of claim 6, wherein the setting parameter comprises one or more from a drink setting input by an occupant, a pre-calibrated temperature corresponding to a drink or entree, a temperature of a space configured to hold a drink or entree, and a surface temperature of the contact surface configured to hold a drink or entree.

8. The apparatus of claim 6, wherein the profile comprises information on drink temperature preferences of an occupant or drink type preferences of an occupant.

9. The apparatus of claim 6, wherein the PTC heating element comprises a cylindrical structure comprising a plurality of fold lines running around a circumferential axis such that the cylindrical structure expands and retracts along a longitudinal axis of the cylindrical structure.

10. The apparatus of claim 1, wherein the PTC heating element is integrated into an inflatable blanket configured to deploy in a vehicle.

11. The apparatus of claim 1, wherein the setting parameter comprises a thermal comfort value and an optimal power consumption value.

12. The apparatus of claim 1, wherein the setting parameter comprises an equivalent homogenous temperature.

13. The apparatus of claim 1, wherein the controller is configured to control the PTC heating element and other HVAC systems according to the setting parameter and the profile.

14. The apparatus of claim 1, further comprising a communication device configured to receive the setting parameter from one or more from among a plurality of sensors.

15. The apparatus of claim 14, wherein the communication device is further configured to receive the profile from one or more of a server and a mobile device.

16. The apparatus of claim 1, further comprising a user input configured to provide the setting parameter to the controller.

17. The apparatus of claim 1, further comprising a storage configured to store the setting parameter and the profile.

18. The apparatus of claim 1, wherein the PTC heating element comprises a ceramic material or silicon rubber.

19. The apparatus of claim 1, wherein the PTC heating element comprises a flexible substrate and carbon-based ink.

20. The apparatus of claim 1, wherein the PTC heating element is flexible.
